(19) United States
(12) Patent Application Publication
(10) Pub. No.: US 2012/0031293 A1
(43) Pub. Date: Feb. 9, 2012

(54) METHOD FOR MAKING LITHOGRAPHIC PRINTING PLATE, LITHOGRAPHIC PRINTING PLATE, AND LITHOGRAPHIC PRINTING PLATE MAKING APPARATUS

(75) Inventor: Yoshiyuki OZAWA, Shiojiri-shi (JP)

(73) Assignee: SEIKO EPSON CORPORATION, Tokyo (JP)

(21) Appl. No.: 13/197,606

(22) Filed: Aug. 3, 2011

(30) Foreign Application Priority Data
Aug. 4, 2010 (JP) 2010-175695

(51) Int. Cl. B41N 1/00; B41N 3/00

(52) U.S. Cl. 101/453; 101/463.1

(57) ABSTRACT

A method for making a lithographic printing plate includes forming an image area on a medium by ejecting an ink onto the medium from a head. The ink contains a water-insoluble polymer acting as a dispersant resin, a pigment coated with the water-insoluble polymer, and a surfactant.

### CROSS REFERENCES TO RELATED APPLICATIONS

The entire disclosure of Japanese Patent Application No. 2010-175695, filed Aug. 4, 2010 is expressly incorporated herein by reference.

### BACKGROUND

1. Technical Field

The present invention relates to a method for making a lithographic printing plate, a lithographic printing plate, and a lithographic printing plate making apparatus.

2. Related Art

A lithographic printing plate includes a lipophilic image area that receives a lipophilic ink and a lipophobic non-image area that does not receive the ink, where the non-image area is generally made of a hydrophilic material that accepts water. For general lithographic printing, water and an ink are applied to the surface of a printing plate. The coloring ink selectively adheres to the image area, and the ink on the image area is transferred to a printing material (for example, printing paper).

A method using silver complex diffusion transfer (DTR) is known as one of the methods for making lithographic printing plates. For example, JP-A-2009-175466 discloses how this method is currently used.

When performing a CTP (Computer To Plate) technique using an ink jet recording method, an image area is formed on the surface of a plate by ejecting a plate-making ink onto the surface so that the plate can function as a lithographic printing plate.

### SUMMARY

An advantage of some aspects of the invention is that it provides CTP techniques using an ink jet recording method.

According to an aspect of the invention, a method for making a lithographic printing plate is provided which includes forming an image area on a medium by ejecting an ink containing a pigment, a water-insoluble polymer acting as a dispersant resin, and a surfactant onto the medium from a head.

Further features of the invention will become apparent from the following description and accompanying drawings.

### BRIEF DESCRIPTION OF THE DRAWINGS

The invention will be described with reference to the accompanying drawings, wherein like numbers reference like elements.

FIG. 1A is a representation of a plate material of a lithographic printing plate;

FIG. 1B is a representation of an operation for making a lithographic printing plate;

FIG. 1C is a representation of a plate surface; and FIG. 1D is a representation of a state of the plate surface that is being subjected to offset printing;

FIG. 2 is a block diagram of a CTP system.

FIG. 3A is a schematic perspective view of a recording apparatus;

FIG. 3B is a sectional view of the recording apparatus shown in FIG. 3A;

FIG. 4 is a representation of a processing of an application program performed by a computer;

FIG. 5 is a representation of recording modes of a control program;

FIGS. 6A and 6B are representations of a setting screen on a computer display, where FIG. 6A shows a default setting screen, and FIG. 6B shows the screen when a plate-making RC paper has been selected;

FIG. 7 is a flow chart of processing of a control program;

FIG. 8 is a representation of an arrangement of nozzles of the head of a recording apparatus;

FIG. 9 is a representation of the relationship between the position of a color nozzle line and dots formed by the color nozzle line; and

FIG. 10 is a representation of an overlap recording method performed by two nozzle lines aligned in the transport direction.

### DESCRIPTION OF EXEMPLARY EMBODIMENTS

The following will become apparent from the description provided herein and the accompanying drawings.

More specifically, a method for making a lithographic printing plate is provided in which an image area is formed on a medium, which acts as a plate material. The image area is formed by ejecting an ink containing a pigment, a water-insoluble polymer acting as a dispersant resin, and a surfactant onto the medium. The particles of the pigment are coated with the water-insoluble polymer. According to this method, printing plates can be made by an ink jet method. In addition, since the pigment is coated with the water-insoluble polymer, this method is advantageous in forming a lipophilic image area.

Preferably, the pigment has an average particle size in the range of 30 to 300 nm. Thus, printing plates can be made by an ink jet method.

Preferably, the solubility of the water-insoluble polymer is less than 1 g in 100 g of water at 25° C. Thus, printing plates can be made by an ink jet method.

Preferably, the head can eject a plurality of chromatic inks, and the chromatic inks are ejected onto the medium from the head to form an image area defined by an achromatic image. Thus, the visibility of the plate surface can be improved.

A lithographic printing plate is also provided which includes a support, an ink-receiving layer that receives an ink, and an image area defined by applying an ink to the ink-receiving layer from an ink jet recording apparatus. The ink contains a water-insoluble polymer acting as a dispersant resin, a pigment coated with the water-insoluble resin, and a surfactant. This lithographic printing plate can be made by an ink jet method. In addition, since the pigment is coated with the water-insoluble polymer, this method is advantageous in forming a lipophilic image area.

A lithographic printing plate making apparatus is also provided which includes a head that ejects an ink containing a water-insoluble resin acting as a dispersant resin, a pigment coated with the water-insoluble polymer, and a surfactant, and a control section that controls the head so as to eject the ink onto a medium to form an image area on the medium. This apparatus can make printing plates using an ink jet method. In addition, the pigment is coated with the water-insoluble polymer. This is advantageous in forming a lipophilic image area.

### Plate Making Overview

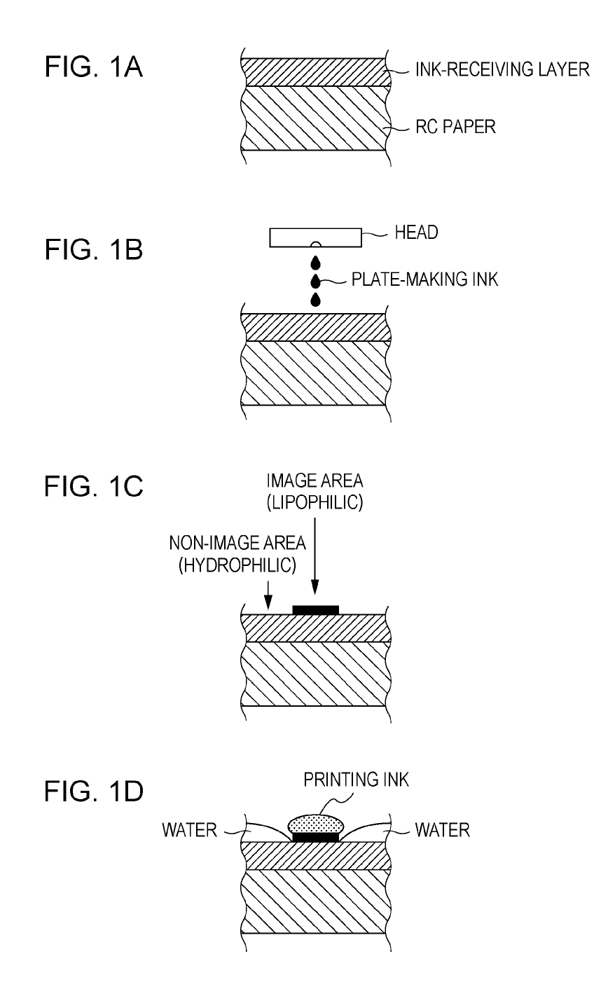

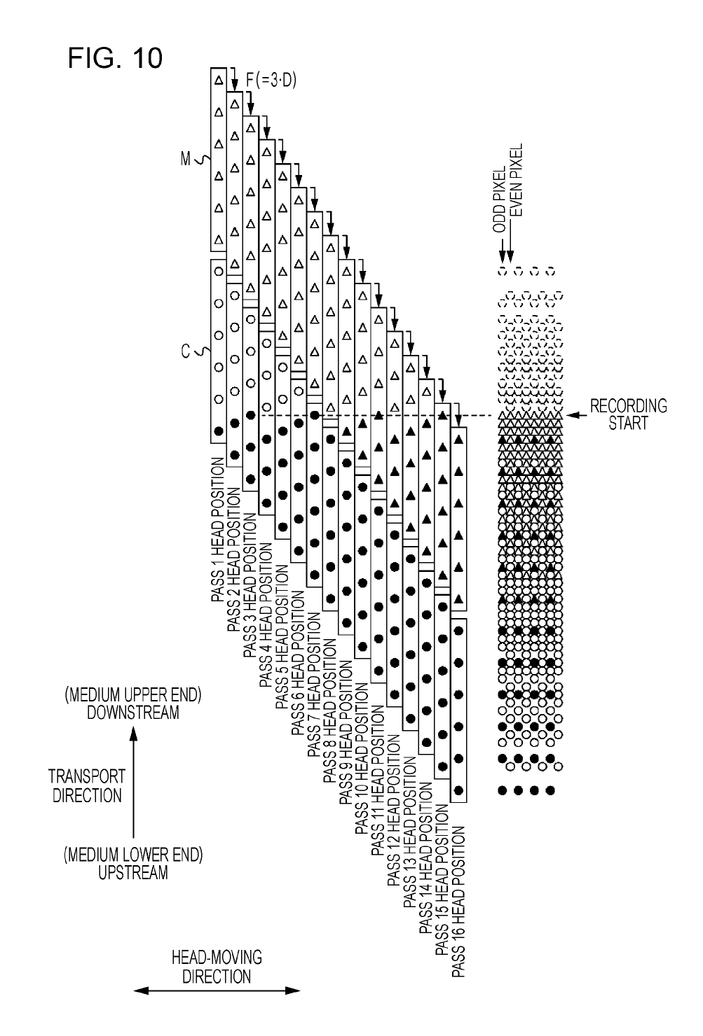

FIG. 1A is a representation of a plate material of a lithographic printing plate. The plate material includes an RC paper and an ink-receiving layer formed on the RC paper. The RC paper is a coated paper prepared by coating the surface of a base paper with a resin; hence it has a resin coating layer (RC layer) and is water-resistant. The ink-receiving layer is porous, and the ink ejected onto the ink-receiving layer is absorbed into the pores. The penetration of the ink absorbed in the ink-receiving layer is blocked by the resin coating layer of the RC paper. The surface of the ink-receiving layer has been subjected to hydrophilic treatment. One of the reasons why the surface of the ink-receiving layer is made hydrophilic is so that the ejected ink can be rapidly absorbed in the ink-receiving layer. Another reason is to make the non-image area hydrophilic, as shown in FIG. 10.

FIG. 1B is a representation of an operation for making a lithographic printing plate. In the present embodiment, a plate-making ink is ejected onto the plate material from the head of an ink jet recording apparatus to form an image directly on the plate material. The plate-making ink is a pigment ink. The composition of the plate-making ink will be described later. The image can be formed in the same manner as in a common printing method using an ink jet printer, and a recording method suitable for plate making is applied. An exemplary recording method will be described later.

FIG. 1C shows the plate surface. An image area is defined by a portion on the plate surface to which the plate-making ink has been applied, and the other portion acts as the non-image area. The image area is lipophilic and the non-image area is hydrophilic.

FIG. 1D shows a state of the plate surface that is being subjected to offset printing. In offset printing, first, the plate surface is wetted with water, and then, an oil-based printing ink is applied to the surface. The printing ink adheres only to the image area, while the hydrophilic non-image area holds the water. Thus, offset printing is performed. Since RC paper is used for the plate material, the base paper of the plate material is not degraded even though the plate surface is wetted with water for offset printing.

In order to make a printing plate directly by using an ink jet recording apparatus, the image area on the plate surface, which has been formed by applying a plate-making ink, must be sufficiently lipophilic. Accordingly, an ink jet recording method that can form a sufficiently lipophilic image area is applied to the present embodiment.

### Plate-Making Ink Composition

The plate-making ink used in the present embodiment contains a water-insoluble polymer acting as a dispersant resin. The water-insoluble polymer functions to enhance the fixability of the pigment applied to the medium. In addition to the function of acting as a dispersant resin and enhancing the fixability, the water-insoluble polymer is lipophilic and has a high affinity for the offset printing ink. Accordingly, lipophilicity is imparted to the image area by applying a plate-making ink containing a water-insoluble polymer to a plate material.

Also, as will be described below, the plate-making ink used in the present embodiment contains a pigment whose particles are coated with the water-insoluble polymer. Since the pigment is deposited on the surface of the plate material, it is particularly advantageous in forming a lipophilic image area that the pigment particles are coated with the water-insoluble polymer.

The water-insoluble polymer used herein has a solubility of less than 1 g in 100 g of water at 25° C. The water-insoluble polymer can be synthesized by solution polymerization using at least a polymerizable unsaturated monomer and a polymerization initiator.

Polymerizable unsaturated monomers include vinyl aromatic hydrocarbons, methacrylic esters, methacrylamide, alkyl-substituted methacrylamides, maleic anhydride, vinyl cyanides, methyl vinyl ketone, and vinyl acetate. Examples of such a polymerizable unsaturated monomer include styrene, α-methylstyrene, vinyl toluene, 4-t-butylstyrene, chlorostyrene, vinylanisole, vinyl naphthalene, methyl methacrylate, ethyl methacrylate, isopropyl methacrylate, n-butyl methacrylate, isobutyl methacrylate, n-amyl methacrylate, isoamyl methacrylate, n-hexyl methacrylate, 2-ethylhexyl methacrylate, octyl methacrylate, decyl methacrylate, dodecyl methacrylate, octadecyl methacrylate, cyclohexyl methacrylate, phenyl methacrylate, benzyl methacrylate, glycidyl methacrylate, acrylonitrile, and methacrylonitrile. These may be used singly or in combination.

Preferably, the water-insoluble polymer contains a monomer having a hydrophilic group and a monomer having a group capable of forming a salt.

Examples of such a monomer having a hydrophilic group include polyethylene glycol monomethacrylate, polypropylene glycol monomethacrylate, and ethylene glycol-propylene glycol monomethacrylate. These monomers may be used singly or in combination. In particular, in order to enhance the visibility and rub fastness of the printing plate, monomer components that can form a branched chain are preferably used. Such monomer components include polyethylene glycol (2 to 30) monomethacrylates, polyethylene glycol (1 to 15)-propylene glycol (1 to 15) monomethacrylates, polypropylene glycol (2 to 30) methacrylates, methoxy polyethylene glycol (2 to 30) methacrylates, methoxy polytetramethylene glycol (2 to 30) methacrylates, and methoxy (ethylene glycol-propylene glycol copolymer)(1 to 30) methacrylates.

Examples of the monomer having a group capable of forming a salt include acrylic acid, methacrylic acid, styrene-carboxylic acid, and maleic acid. These monomers may be used singly or in combination.

In addition, macromonomers and other monomers, such as styrene-based macromonomers having a polymerizable functional group at one end and silicone-based macromonomers, may be used in combination.

For the polymerization, a known radical polymerization agent or polymerization chain transfer agent may be added. The organic pigment coated with the water-insoluble polymer can be prepared by phase inversion emulsification. More specifically, for example, a water-insoluble polymer is dissolved in an organic solvent, such as methanol, ethanol, isopropanol, n-butanol, acetone, methyl ethyl ketone, or dibutyl ether, and an organic pigment is added to the solution of the water-insoluble polymer. A neutralizer and water are added to the mixture and dispersed to yield an oil-in-water type dispersion. Then, the organic solvent is removed from the dispersion. The organic pigment coated with a water-insoluble polymer is thus prepared using a water dispersion. The mixing and dispersing operation is performed in, for example, a ball mill, a roll mill, a bead mill, a high-pressure homogenizer, or a high-speed submerged disperser.

Preferably, the neutralizer is a tertiary amine, such as ethylamine or trimethylamine, or lithium hydroxide, sodium hydroxide, potassium hydroxide, or ammonia, and is such that the resulting water dispersion can have a pH of 6 to 10.

Preferably, the water-insoluble polymer coating the pigment has a weight average molecular weight of about 10,000 to 150,000, from the viewpoint of stably dispersing a coloring agent or the pigment. The weight average molecular weight can be measured by gel permeation chromatography (GPC).

Furthermore, the water-insoluble polymer in the ink composition has a volume average particle size in the range of 30 to 300 nm, more preferably in the range of 40 to 140 nm, from the viewpoint of the lipophilicity and fixability of the image area. The volume average particle size can be measured with a Microtrac UPA 150 (manufactured by Microtrac) or a particle size distribution analyzer LPA 3100 (manufactured by Otsuka electronics).

In the present embodiment, a yellow ink composition, a magenta ink composition, and a cyan ink composition are preferably used as color ink compositions. Pigments in the color ink compositions include Pigment Yellows, Pigment Reds, Pigment Violets and Pigment Blues designated by color indexes. Examples of those pigments include C. I. Pigment Yellows 1, 3, 12, 13, 14, 17, 24, 34, 35, 37, 42, 53, 55, 74, 81, 83, 95, 97, 98, 100, 101, 104, 108, 109, 110, 117, 120, 128, 138, 147, 150, 153, 155, 174, 180, 188, and 198; C. I. Pigment Reds 1, 3, 5, 8, 9, 16, 17, 19, 22, 38, 57:1, 90, 112, 122, 123, 127, 146, 184, 202, 207, and 209; C. I. Pigment Violets 1, 3, 5:1, 16, 19, 23, and 38; C. I. Pigment Blues 1, 2, 15, 15:1, 15:2, 15:3, 15:4, and 16; and C. I. Pigment Blacks 1 and 7. A plurality of pigments may be combined to prepare an ink composition.

In particular, it is preferable that the yellow ink composition contain at least one organic pigment selected from the group consisting of C. I. Pigment Yellows 74, 109, 110, 128, 138, 147, 150, 155, 180, and 188. Also, it is preferable that the magenta ink composition contain at least one organic pigment selected from the groups consisting of C. I. Pigment Reds 122, 202, 207 and 209, and C. I. Pigment Violet 19. Also, it is preferable that the cyan ink composition contain at least one organic pigment selected from the group consisting of C. I. Pigment Blues 15, 15:1, 15:2, 15:3, 15:4, and 16.

Pigments not designated by color indexes may be used as long as they do not dissolve in water.

The content of the pigment coated with the water-insoluble polymer in the color ink composition is preferably in the range of 0.5% to 8% by weight. If the pigment content is less than 0.5% by weight, the image area may not exhibit satisfactory lipophilicity. In contrast, if it is more than 8% by weight, problems with reliability may occur, such as nozzle clogging or unstable ejection.

Preferably, the content ratio of the organic pigment to the water-insoluble polymer is 1:0.2 to 1:1, from the viewpoint of dispersion stability and storage stability of the ink, and prevention of nozzle clogging. More specifically, if the ratio of the water-insoluble polymer to the organic pigment is less than 20%, the pigment cannot be stably dispersed and is, consequently, aggregated. If it is more than 100%, bronzing is reduced, but the visibility of the plate is reduced.

Furthermore, the pigment in the color ink composition preferably has a volume average particle size in the range of 30 to 300 nm from the viewpoint of the lipophilicity and fixability of the image area. The volume average particle size can be measured with Microtrac UPA 150 (manufactured by Microtrac) or a particle size distribution analyzer LPA 3100 (manufactured by Otsuka electronics).

The pigment coated with the water-insoluble polymer need not be completely covered with the water-insoluble polymer and may be partially exposed.

The color ink composition contains a resin emulsion from the viewpoint of imparting fixability and uniformity to the image area.

In the present embodiment, the resin emulsion contains a water-insoluble polymer having a weight average molecular weight of 75,000 to 600,000. The use of such a resin emulsion can provide an ink composition having good fixability and exhibiting high reliability. If the weight average molecular weight of the resin emulsion is outside this range, the reliability is likely to be degraded. For example, when it is less than 75,000, the ink composition does not sufficiently adhere. When it is more than 600,000, the ink composition is not stably ejected.

This water-insoluble polymer can be prepared by copolymerizing monomers using a known polymerization method, such as bulk polymerization, solution polymerization, suspension polymerization, or emulsion polymerization. The resulting polymer is subjected to phase inversion emulsification in water or emulsion polymerization in water to yield the resin emulsion.

In general, if a polymer additive is added to a dispersion of a coloring agent dispersed with a polymer dispersant, the polymer dispersant and the polymer additive are adsorbed to or desorbed from the coloring agent, so that the coloring agent cannot be stably dispersed and, thus, the storage stability is degraded. In the present embodiment, the pigment in the color ink composition is coated with a water-insoluble polymer so that the particles of the pigment can be stably present in a dispersion. Since the water-insoluble polymer and the resin emulsion do not easily cause adsorption and desorption, the pigment can maintain the dispersion stability. In particular, resins having an internal cross-linked structure are preferred as the resin of the resin emulsion because of their high stability. Also, a resin having a similar structure to the water-insoluble polymer coating the pigment is preferred because the pigment can be stably dispersed even if the water-insoluble polymer and the resin emulsion cause adsorption and desorption. The words “similar structure” mentioned herein mean that the resin of the resin emulsion contains the same components as the water-insoluble polymer coating the pigment.

Preferably, the resin emulsion has a volume average particle size in the range of 20 to 200 nm from the viewpoint of ensuring dispersion stability and reducing bronzing. The volume average particle size can be measured with Microtrac UPA 150 (manufactured by Microtrac) or a particle size distribution analyzer LPA 3100 (manufactured by Otsuka electronics).

For preparing a yellow ink composition, preferably, the resin emulsion has a volume average particle size of 20 to 80 nm and contains a water-insoluble polymer that does not form a film at temperatures of 40° C. or less, from the viewpoint of ensuring a high dispersion stability and enhancing the rub fastness of the image area. The water-insoluble polymer that does not form a film at 40° C. or less is added so that the fine particles of the resin remaining on the surface of the recording medium can reduce the slip of the surface to prevent the image area from separating from the surface by being rubbed, but is not intended to enhance the fixability or the rub fastness that can be enhanced by forming a film. In the use of such a water-insoluble polymer, the reliability, for example, recovery from clogging, is significantly higher than in the case of using a polymer that can form a film at 40° C. or less.

Preferably, the water-insoluble polymer that does not form a film at 40° C. or less is at least one selected from the group consisting of acrylic polymers, methacrylic polymers, styrene polymers, urethane polymers, acrylamide polymers, and epoxy polymers. These polymers may be homopolymers or copolymers, or may have a single-phase structure or a multi-phase (core-shell) structure. Preferably, it is a polymer that has been internally cross-linked using a cross-linking agent.

The water-insoluble polymer advantageously used in the yellow ink composition is in a form of an emulsion containing resin particles produced by emulsion polymerization of an unsaturated monomer. This is because the water-insoluble polymer in a form of particles may not be sufficiently dispersed. From the viewpoint of producing an ink, it is preferable that the water-insoluble polymer be in a form of emulsion.

An emulsion of resin particles can be prepared by a known emulsion polymerization method. For example, an unsaturated monomer, such as unsaturated vinyl monomer, can be subjected to emulsion polymerization in water containing a polymerization initiator and a surfactant.

Unsaturated monomers conventionally used for emulsion polymerization can be used. Examples of such an unsaturated monomer include acrylic ester monomers, methacrylic ester monomers, aromatic vinyl monomers, vinyl ester monomers, vinyl cyanide monomers, halogenated monomers, olefin monomers, and diene monomers. More specifically, examples of such an unsaturated monomer include acrylic esters, such as methyl acrylate, ethyl acrylate, isopropyl acrylate, n-butyl acrylate, isobutyl acrylate, n-amyl acrylate, isoamyl acrylate, n-hexyl acrylate, 2-ethylhexyl acrylate, octyl acrylate, decyl acrylate, dodecyl acrylate, octadecyl acrylate, cyclohexyl acrylate, phenyl acrylate, benzyl acrylate, and glycidyl acrylate; methacrylic esters, such as methyl methacrylate, ethyl methacrylate, isopropyl methacrylate, n-butyl methacrylate, isobutyl methacrylate, n-amyl methacrylate, isoamyl methacrylate, n-hexyl methacrylate, 2-ethylhexyl methacrylate, octyl methacrylate, decyl methacrylate, dodecyl methacrylate, octadecyl methacrylate, cyclohexyl methacrylate, phenyl methacrylate, benzyl methacrylate, and glycidyl methacrylate; vinyl esters, such as vinyl acetate; vinyl cyanides, such as acrylonitrile and methacrylonitrile; halogenated monomers, such as vinylidene chloride and vinyl chloride; aromatic vinyl monomers, such as styrene, α-methylstyrene, vinyltoluene, 4-t-butylstyrene, chlorostyrene, vinylanisole, and vinylnaphthalene; olefins, such as ethylene and propylene; dienes, such as butadiene and chloroprene; vinyl monomers, such as vinyl ether, vinyl ketone, and vinyl pyrrolidone; unsaturated carboxylic acids, such as acrylic acid, methacrylic acid, itaconic acid, fumaric acid, and maleic acid; acrylamide compounds, such as acrylamide, methacrylamide, and N,N′-dimethylacrylamide; and hydroxy group-containing monomers, such as 2-hydroxyethyl acrylate, 2-hydroxypropyl acrylate, 2-hydroxyethyl methacrylate, and 2-hydroxypropyl methacrylate. These monomers may be used singly or in combination.

A crosslinkable monomer having at least two polymerizable double bonds may be used as a cross-linking agent. Examples of such a crosslinkable monomer include diacrylate compound, such as polyethylene glycol diacrylate, triethylene glycol diacrylate, 1,3-butylene glycol diacrylate, 1,4-butylene glycol diacrylate, 1,6-hexanediol diacrylate, neopentyl glycol diacrylate, 1,9-nonanediol diacrylate, polypropylene glycol diacrylate, 2,2′-bis(4-acryloxypropyloxyphenyl)propane, and 2,2′-bis(4-acryloxydiethoxyphenyl)propane; triacrylate compounds, such as trimethylolpropane triacrylate, trimethylolethane triacrylate, and tetramethylolmethane triacrylate; tetraacrylate compounds, such as ditrimethylol tetra acrylate, tetramethylolmethane tetraacrylate, and pentaerythritol tetraacrylate; hexaacrylate compounds, such as dipentaerythritol hexaacrylate; dimethacrylate compounds, such as ethylene glycol dimethacrylate, diethylene glycol dimethacrylate, triethylene glycol dimethacrylate, polyethylene glycol dimethacrylate, 1,3-butylene glycol dimethacrylate, 1,4-butylene glycol dimethacrylate, 1,6-hexanediol dimethacrylate, neopentyl glycol dimethacrylate, dipropylene glycol dimethacrylate, polypropylene glycol dimethacrylate, polybutylene glycol dimethacrylate, and 2,2′-bis(4-methacryloxydiethoxyphenyl)propane; trimethacrylate compounds, such as trimethylolpropane trimethacrylate and trimethylolethane trimethacrylate; and methylene bisacrylamide and divinylbenzene. These may be used singly or in combination.

In addition to the polymerization initiator and surfactant used for the emulsion polymerization, a chain transfer agent, and further a neutralizer may be used according to conventional manufacturing processes of inks used in ink jet printers. Preferred neutralizers include ammonia, inorganic alkali metal hydroxides, such as sodium hydroxide and potassium hydroxide.

For preparing a magenta ink composition and a cyan ink composition, it is preferable that a resin emulsion prepared by a phase inversion emulsification, which can stably emulsify a more hydrophilic water-insoluble polymer, be added so that the resulting ink composition exhibits a high dispersion stability and so that the image area has a high fixability. Preferably, this resin emulsion has a volume average particle size in the range of 50 to 200 nm from the viewpoint of ensuring dispersion stability and reducing bronzing.

The resin emulsion advantageously used in the magenta ink composition and the cyan ink composition contains a block copolymer resin of a monomer having a hydrophobic group and a monomer having a hydrophilic group, and the block copolymer contains a monomer having a group capable of forming a salt. In particular, resins having a similar structure to the water-insoluble polymer coating the pigment are preferred because the pigment can be stably dispersed even if absorption and desorption of the water-insoluble polymer and the resin emulsion occur in the ink composition containing both the water-insoluble polymer coating the pigment and a resin having a similar structure. The words “similar structure” mentioned herein mean that the constituents of the resin emulsion are the same as those of the water-insoluble polymer coating the pigment.

Examples of the monomer having a hydrophobic group include methacrylic acid esters, such as methyl methacrylate, ethyl methacrylate, isopropyl methacrylate, n-butyl methacrylate, isobutyl methacrylate, n-amyl methacrylate, isoamyl methacrylate, n-hexyl methacrylate, 2-ethylhexyl methacrylate, octyl methacrylate, decyl methacrylate, dodecyl methacrylate, octadecyl methacrylate, cyclohexyl methacrylate, phenyl methacrylate, benzyl methacrylate, and glycidyl methacrylate; vinyl esters, such as vinyl acetate; vinyl cyanides, such as acrylonitrile and methacrylonitrile; and aromatic vinyl monomers, such as styrene, α-methylstyrene, vinyltoluene, 4-t-butylstyrene, chlorostyrene, vinyl anisole, and vinylnaphthalene. These monomers may be used singly or in combination.

Examples of the monomer having a hydrophilic group include polyethylene glycol monomethacrylate, polypropylene glycol monomethacrylate, and ethylene glycol-propylene glycol monomethacrylate. These monomers may be used singly or in combination. In particular, monomer components that can form a branched chain are preferably used. Such monomer components include polyethylene glycol (2 to 30) monomethacrylates, polyethylene glycol (1 to 15)-propylene glycol (1 to 15) monomethacrylates, polypropylene glycol (2 to 30) methacrylates, methoxy polyethylene glycol (2 to 30) methacrylates, methoxy polytetramethylene glycol (2 to 30) methacrylates, and methoxy (ethylene glycol-propylene glycol copolymer) (1 to 30) methacrylates.

Examples of the monomer having a group capable of forming a salt include acrylic acid, methacrylic acid, styrene-carboxylic acid, and maleic acid. These monomers may be used singly or in combination.

In addition, macromonomers and other monomers, such as styrene-based macromonomers having a polymerizable functional group at one end and silicone-based macromonomers, may be used in combination.

The water-insoluble polymer used in the color ink composition can be produced by polymerizing a monomer using a known polymerization method, such as bulk polymerization, solution polymerization, suspension polymerization, or emulsion polymerization, and preferably by solution polymerization. For the polymerization, a known radical polymerization agent or a polymerization chain transfer agent may be added.

The polymerized resin is dissolved in an organic solvent. A neutralizer and water are added to the resin solution, and the mixture is dispersed. Then, the organic solvent is removed from the dispersion to yield the resin emulsion.

Preferably, the neutralizer is a tertiary amine, such as ethylamine or trimethylamine, or lithium hydroxide, sodium hydroxide, potassium hydroxide, or ammonia, and is such that the resulting water dispersion can have a pH of 6 to 10.

By using the resin emulsion and the pigment coated with the water-insoluble polymer in combination, the degradation in visibility, which occurs as the proportion of the water-insoluble polymer to the pigment is increased, can be prevented. In addition, since the content of the resin components in the ink composition is increased, the rub fastness in terms of fixability or gloss change can be enhanced.

The resin emulsion content in the color ink composition is preferably in the range of 0.1% to 5% by weight in view of appropriate properties and reliability (such as anti-clogging property and ejection stability) of the ink composition in the ink jet method.

Preferably, the resin emulsions in the cyan, magenta and yellow ink compositions each contain different constituents. If the resin emulsions in the color ink compositions have different properties from each other, the composite black of the three color inks can exhibit a higher fixability and rub fastness than a case where the resin emulsions in color inks have the same properties.

Preferably, the ink composition of the present embodiment further contains water, a water-soluble organic compound, a pH adjuster, and a nonionic surfactant.

Preferably, the water in the ink composition is a main solvent and is pure water or ultrapure water, such as ion exchanged water, ultrafiltered water, reverse osmotic water, or distilled water. In particular, the water is preferably sterilized by, for example, UV irradiation or addition of hydrogen peroxide or the like. The use of sterile water can prevent the occurrence of mold or bacteria and thus allows long-term storage.

Water-soluble organic compounds include: polyhydric alcohols, such as glycerol, 1,2,6-hexanetriol, trimethylolpropane, ethylene glycol, propylene glycol, diethylene glycol, triethylene glycol, tetraethylene glycol, pentaethylene glycol, dipropylene glycol, 2-butene-1,4-diol, 2-ethyl-1,3-hexanediol, 2-methyl-2,4-pentanediol, 1,2-octanediol, 1,2-hexanediol, 1,2-pentanediol, 1,5-pentanediol, and 4-methyl-1,2-pentanediol; saccharides, such as glucose, mannose, fructose, ribose, xylose, arabinose, galactose, aldonic acid, glucitol, (sorbitol), maltose, cellobiose, lactose, sucrose, trehalose, and maltotriose; sugar alcohols; hyaluronic acids; solid wetting agents, such as trimethylolethane, trimethylolpropane, urea, and urea derivatives (for example, dimethyl urea); alkyl alcohols having a carbon number of 1 to 4, such as ethanol, methanol, butanol, propanol, and isopropanol; glycol ethers, such as ethylene glycol monomethyl ether, ethylene glycol monoethyl ether, ethylene glycol monobutyl ether, ethylene glycol monomethyl ether acetate, diethylene glycol monomethyl ether, diethylene glycol monoethyl ether, diethylene glycol mono-n-propyl ether, ethylene glycol monoisopropyl ether, diethylene glycol monoisopropyl ether, ethylene glycol mono-n-butyl ether, ethylene glycol mono-t-butyl ether, diethylene glycol mono-t-butyl ether, triethylene glycol monobutyl ether, 1-methyl-1-methoxybutanol, propylene glycol monomethyl ether, propylene glycol monoethyl ether, propylene glycol mono-t-butyl ether, propylene glycol mono-n-propyl ether, propylene glycol monoisopropyl ether, dipropylene glycol monomethyl ether, dipropylene glycol monoethyl ether, dipropylene glycol mono-n-propyl ether, and dipropylene glycol monoisopropyl ether; 2-pyrrolidone and N-methyl-2-pyrrolidone; 1,3-dimethyl-2-imidazolidinone; formamide and acetamide; dimethyl sulfoxide; sorbitol and sorbitan; acetin, diacetin, and triacetin; and sulfolane. These may be used singly or in combination. The water-soluble organic compound content in the ink composition is preferably in the range of 10% to 50% by weight from the viewpoint of ensuring appropriate properties (for example, viscosity) and ensuring recording quality and reliability.

In the present embodiment, preferably, a polyhydric alcohol, a solid lubricant, and a butyl ether of glycols are used in combination as the water-soluble organic compound. The combined use of these water-soluble organic compounds can provide a reliable ink composition superior in recording quality, ejection stability and recovery from clogging. Polyhydric alcohols and solid lubricants are suitable to control the moisture-retaining properties and the penetration of the ink composition into the medium, and butyl ethers of glycols are suitable to control the ejection stability and the penetration of the ink composition into the medium. By combining these compounds, the resulting ink composition can be made reliable in terms of recording quality, ejection stability and recovery from clogging.

In a preferred combination of water-soluble organic compounds, the polyhydric alcohols are at least two selected from the groups consisting of glycerol, diethylene glycol, triethylene glycol, 1,5-pentanediol and 1,2-hexanediol, and the solid wetting agent is selected from the group consisting of trimethylolethane, trimethylolpropane and urea. Also, the butyl glycol is diethylene glycol monobutyl ether or triethylene glycol monobutyl ether.

Preferably, the ink composition contains a pH adjuster. Examples pH adjusters include alkali metal hydroxides, such as lithium hydroxide, potassium hydroxide, and sodium hydroxide; and ammonia and alkanolamines, such as triethanolamine, tripropanolamine, diethanolamine, and monoethanolamine. Preferably, the ink composition is adjusted to a pH of 6 to 10 by adding at least one pH adjuster selected from the group consisting of alkali metal hydroxides, ammonia, triethanolamine, and tripropanolamine. If the pH of the ink composition is outside this range, the materials of the ink jet printer are adversely affected, or the printer becomes difficult to recover from clogging.

In addition, a pH buffer may be used, such as collidine, imidazole, phosphoric acid, 3-(N-morpholino)propanesulfonic acid, tris(hydroxymethyl)aminomethane, and boric acid, if necessary.

The above trialkanolamines, such as triethanolamine and tripropanolamine, can act as an agent for imparting a gloss to the ink composition, and may be added to the yellow, magenta and cyan ink compositions so that a uniformly glossy image can be formed on the surface of a glossy plate material. A uniformly glossy surface of the printing plate provides a high visibility in visually checking the plate surface immediately after the completion of plate making.

The amount of the trialkanolamine used to impart a gloss to the ink composition is preferably in the range of 10% to 50% by weight, more preferably in the range of 12% to 45% by weight, relative to 100% by weight of pigment. Also, its content in the ink composition is preferably 1% by weight or more, more preferably in the range of 1% to 3% by weight.

Although any trialkanolamine may be used to impart a gloss to the ink composition, triethanolamine and/or tripropanolamine is preferred from the viewpoint of enhancing the recording stability and the gloss.

The ink composition may further contain a surfactant, an antifoaming agent, an antioxidant, an ultraviolet light absorbent, a preservative, an antifungal agent and other additives, if necessary.

The surfactant can be selected from the known anionic surfactants, cationic surfactants, amphoteric surfactants and nonionic surfactants. From the viewpoint of producing an ink composition that does not easily foam, nonionic surfactants are preferred.

Nonionic surfactants include acetylene glycol surfactants; acetylene alcohol surfactants; ethers, such as polyoxyethylene nonylphenyl ether, polyoxyethylene octylphenyl ether, polyoxyethylene dodecylphenyl ether, polyoxyethylene alkylallyl ether, polyoxyethylene oleyl ether, polyoxyethylene lauryl ether, polyoxyethylene alkyl ether, and polyoxyalkylene alkyl ether; esters, such as polyoxyethylene oleic acid, polyoxyethylene oleic acid ester, polyoxyethylene distearic acid ester, sorbitan laurate, sorbitan monostearate, sorbitan monooleate, sorbitan sesquioleate, polyoxyethylene monooleate, and polyoxyethylene stearate; polyether-modified siloxane-based surfactants, such as dimethylpolysiloxane; and fluorine-containing surfactants, such as fluoroalkyl esters and perfluoroalkylcarboxylates. These nonionic surfactants may be used singly or in combination.

Among those nonionic surfactants, acetylene glycol surfactants and/or polyether-modified siloxane-based surfactants are preferred. These do not easily foam and have antifoaming ability.

Exemplary acetylene glycol surfactants include 2,4,7,9-tetramethyl-5-decyne-4,7-diol, 3,6-dimethyl-4-octyne-3,6-diol, and 3,5-dimethyl-1-hexyne-3-ol. Commercially available acetylene glycol surfactants may be used, such as Surfinols 104, 82, 465, 485 and TG produced by Air Products, and Olfine STG and Olfine E1010 produced by Nisshin Chemical Industry. Exemplary polyether-modified siloxane-based surfactants include BYK-345, BYK-346, BYK-347, BYK-348 and UV3530, each produced by BYK. These surfactants may be used in combination in the ink composition, and are preferably contained in the range of 0.1% to 3.0% by weight so as to adjust the surface tension to 20 to 40 mN/m.

Antioxidants and ultraviolet light absorbents include allophanates, such as allophanate and methyl allophanate; biurets, such as biuret, dimethyl biuret, and tetramethyl biuret; L-ascorbic acid and its salts; Tinuvins 328, 900, 1130, 384, 292, 123, 144, 622, 770 and 292, Irgacors 252 and 153, and Irganoxes 1010, 1076, 1035 and MD1024 (each produced by Ciba-Geigy), and lanthanide oxides.

Preservatives or fungicides include sodium benzoate, sodium pentachlorophenol, sodium-2-pyridine thiol-1-oxide, sodium sorbate, sodium dehydroacetate, and 1,2-dibenzisothiazolin-3-one (Proxel CRL, Proxel BDN, Proxel GXL, Proxel XL-2, and Proxel TN, each produced by Avecia).

The ink composition can be prepared in the same manner as inks used in ink jet printers, using a known apparatus, such as ball mill, sand mill, attritor, basket mill or roll mill. In order to prevent clogging of nozzles, it is preferable that large particles be removed in the preparation of the ink composition. Large particles, preferably particles having a particle size of 10 μm or more and more preferably 5 μm or more, are removed by, for example, filtering the mixture of ink materials through a membrane filter or a mesh filer.

### EXAMPLE

### Comparative Example

### Preparation of Pigment Dispersion Liquid for Black Ink Composition

For the sake of comparison, a dispersion liquid containing a pigment whose particles were not coated with a water-insoluble polymer was prepared as below. The particle size mentioned herein is a volume average particle size determined from a particle size distribution analysis using Microtrac UPA150 (manufacture by Microtrac).

Dispersion Liquid B1

With 500 g of water was mixed 100 g of MA8 (produced by Mitsubishi Chemical), which is a commercially available carbon black, and the mixture was pulverized with zirconia beads in a ball mill. In the liquid containing the pulverized carbon black was dropped 500 g of sodium hypochlorite (effective chlorine concentration: 12%), and wet oxidation was performed by boiling the mixture with stirring for 10 hours. The resulting dispersion liquid was filtered through a glass fiber filter GA-100 (available from Advantech Toyo), followed by washing with water. The resulting wet cake was dispersed again in 5 kg of water and purified by deionization through a reverse osmosis membrane until the electric conductivity was reduced to 2 mS/cm. Further, the dispersion was concentrated to a pigment concentration of 15% by weight to yield dispersion liquid B1. The volume average particle size of the pigment in the dispersion liquid was 120 nm.

### Dispersion Liquid B2

To 500 g of water was added 20 g of Color Black S170 (produced by Degussa), which is a commercially available carbon black, and the mixture was dispersed with a home mixer for 5 minutes. The resulting liquid was placed in a 3 L glass vessel equipped with a stirrer, and a gas containing 8% by weight of ozone was introduced to the vessel at a flow rate of 500 cc/min with stirring. In this operation, the ozone was generated with an electrogeneration-type ozone generator or ozonizer manufactured by Permelec Electrode. The resulting dispersion was filtered through a glass fiber filter GA-100 (available from Advantech Toyo), and the filtrate was concentrated to a pigment concentration of 15% by weight while 0.1 N potassium hydroxide solution was being added to adjust the pH to 9. Thus dispersion liquid B2 was prepared. The volume average particle size of the pigment in the dispersion liquid was 90 nm.

### Dispersion Liquid B3

A commercially available black pigment dispersion liquid CAB-O-JET 300 (produced by Cabot, pigment solid content: 15% by weight) was used. The volume average particle size of the pigment in the dispersion liquid was 140 nm.

### Preparation of Pigment Dispersion Liquids for Color Ink Compositions

A dispersion liquid of a pigment coated with a water-insoluble polymer was prepared as below. The particle size mentioned herein is a volume average particle size determined from a particle size distribution analysis using Microtrac UPA150 (manufacture by Microtrac).

### Synthesis of Water-Insoluble Polymers 1 to 3

A reaction vessel sufficiently purged with nitrogen gas was charged with 20 parts by weight of organic solvent (methyl ethyl ketone), 0.03 parts by weight of polymerization chain transfer agent (2-mercaptoethanol), a polymerization initiator, and monomers shown in Table 1, and polymerization was performed at 75° C. with stirring. Relative to 100 parts by weight of monomer components, 0.9 parts by weight of 2,2′-azobis(2,4-dimethylvaleronitrile) dissolved in 40 parts by weight of methyl ethyl ketone was added, and the mixture was aged at 80° C. for one hour to yield a polymer solution. Values shown in Table 1 each represent a percentage of the corresponding monomer in the total amount (100%) of the monomer mixture.

TABLE 1

| | Water- | Water- | Water- |
|---|---|---|---|
| Monomer mixture | insoluble | insoluble | insoluble |
| composition (%) | polymer 1 | polymer 2 | polymer 3 |
| Methacrylic acid | 20 | 15 | 20 |
| Styrene monomer | 45 | 30 | 40 |
| Benzyl methacrylate | | 20 | |
| Polyethylene glycol | 5 | 10 | |
| monomethacrylate | | | |
| (EO = 15) | | | |
| Polypropylene glycol | | 10 | 25 |
| monomethacrylate | | | |
| (PO = 9) | | | |
| Polyethylene glycol- | 10 | | 5 |
| polypropylene glycol | | | |
| monomethacrylate | | | |
| (EO = 5, PO = 7) | | | |
| Styrene macromonomer | 20 | 15 | 10 |

EP: ethylene oxide
PO: propylene oxide

### Dispersion Liquid Y1

The polymer solution of water-insoluble polymer 1 was dried under reduced pressure, and 5 parts of dried water-insoluble polymer 1 was dissolved in 15 parts of methyl ethyl ketone, followed by being neutralized with an aqueous solution of sodium hydroxide. Then, 15 parts of C. I. Pigment Yellow 74 was added, and the mixture was agitated with a disperser while water was being added.

After 100 parts of ion exchanged water was added to the resulting mixture and stirred, the methyl ethyl ketone was removed at 60° C. under reduced pressure, and part of the water was removed to yield a water dispersion of a yellow pigment having a solid content of 20% by weight. The ratio of the pigment to the water-insoluble polymer was 1 to 0.3. The volume average particle size of the pigment in the dispersion was 110 nm.

### Dispersion Liquid Y2

The polymer solution of water-insoluble polymer 2 was dried under reduced pressure, and 9 parts of dried water-insoluble polymer 2 was dissolved in 45 parts of methyl ethyl ketone, followed by being neutralized with an aqueous solution of sodium hydroxide. Then, 18 parts of C. I. Pigment Yellow 128 was added, and the mixture was agitated with a disperser while water was being added.

After 120 parts of ion exchanged water was added to the resulting mixture and stirred, the methyl ethyl ketone was removed at 60° C. under reduced pressure, and part of the water was removed to yield a water dispersion of a yellow pigment having a solid content of 20% by weight. The ratio of the pigment to the water-insoluble polymer was 1 to 0.5. The volume average particle size of the pigment in the dispersion was 80 nm.

### Dispersion Liquid Y3

The polymer solution of water-insoluble polymer 3 was dried under reduced pressure, and 6 parts of dried water-insoluble polymer 3 was dissolved in 20 parts of methyl ethyl ketone, followed by being neutralized with an aqueous solution of sodium hydroxide. Then, 10 parts of C. I. Pigment Yellow 180 was added, and the mixture was agitated with a disperser while water was being added.

After 100 parts of ion exchanged water was added to the resulting mixture and stirred, the methyl ethyl ketone was removed at 60° C. under reduced pressure, and part of the water was removed to yield a water dispersion of a yellow pigment having a solid content of 20% by weight. The ratio of the pigment to the water-insoluble polymer was 1 to 0.6. The volume average particle size of the pigment in the dispersion was 100 nm.

### Dispersion Liquid M1

Dispersion Liquid M1 was prepared in the same manner as Dispersion Liquid Y1 except that C. I. Pigment Red 122 was used instead of C. I. Pigment Yellow 74. The volume average particle size of the pigment in the dispersion liquid was 100 nm.

### Dispersion Liquid M2

Dispersion Liquid M2 was prepared in the same manner as Dispersion Liquid Y2 except that C. I. Pigment Violet 19 was used instead of C. I. Pigment Yellow 128 in a pigment-to-water-insoluble polymer ratio of 1 to 0.2. The volume average particle size of the pigment in the dispersion liquid was 90 nm.

### Dispersion Liquid M3

Dispersion Liquid M3 was prepared in the same manner as Dispersion Liquid Y3 except that C. I. Pigment Red 209 was used instead of C. I. Pigment Yellow 180 in a pigment-to-water-insoluble polymer ratio of 1 to 0.15. The volume average particle size of the pigment in the dispersion liquid was 120 nm.

### Dispersion Liquid C1

Dispersion Liquid C1 was prepared in the same manner as Dispersion Liquid Y1 except that C. I. Pigment Blue 15:3 was used instead of C. I. Pigment Yellow 74. The volume average particle size of the pigment in the dispersion liquid was 80 nm.

### Dispersion Liquid C2

Dispersion Liquid C2 was prepared in the same manner as Dispersion Liquid Y2 except that C. I. Pigment Blue 15:1 was used instead of C. I. Pigment Yellow 128 in a pigment-to-water-insoluble polymer ratio of 1 to 0.8. The volume average particle size of the pigment in the dispersion liquid was 85 nm.

### Dispersion Liquid C3

Dispersion Liquid C3 was prepared in the same manner as Dispersion Liquid Y3 except that C. I. Pigment Blue 15:4 was used instead of C. I. Pigment Yellow 180 in a pigment-to-water-insoluble polymer ratio of 1 to 1. The volume average particle size of the pigment in the dispersion liquid was 100 nm.

### Preparation of Resin Emulsion

Resin emulsions used in the color ink compositions and the black ink compositions were prepared as below. Whether or not the resin emulsion can form a film was determined by visually observing a thin coating of the emulsion applied on an aluminum plate at room temperature of about 25° C. The weight average molecular weight was measured by gel permeation chromatography (GPC). The particle size mentioned herein is an average particle size determined from a particle size distribution analysis using Microtrac UPA150 (manufacture by Microtrac).

### Resin Emulsion 1

A reaction vessel equipped with a stirrer, a reflux condenser, a dropping funnel, and a thermometer was charged with 800 g of ion exchanged water and 1 g of sodium lauryl sulfate. The reaction vessel was heated to 75° C. while being purged with nitrogen with stirring. With the temperature in the vessel kept at 75° C., 6 g of potassium persulfate was added as a polymerization initiator and dissolved. Then an emulsion prepared by adding 20 g of acrylamide, 600 g of methyl methacrylate, 215 g of butyl acrylate, 30 g of methacrylic acid, and 5 g of triethylene glycol diacrylate to 450 g of ion exchanged water and 2 g of sodium lauryl sulfate with stirring was continuously dropped into the reaction solution over a period of 5 hours. After dropping the emulsion, the reaction liquid was aged for 3 hours. The resulting resin emulsion was cooled to room temperature, and ion exchanged water and a sodium hydroxide aqueous solution were added to the resin emulsion to adjust the solid content to 30% by weight and the pH to 8.

The resulting resin emulsion was confirmed that it does not form a film at 40° C. The weight average molecular weight was 300,000, and the volume average particle size was 80 nm.

### Resin Emulsion 2

A reaction vessel equipped with a stirrer, a reflux condenser, a dropping funnel, and a thermometer was charged with 1000 g of ion exchanged water and 6.5 g of sodium lauryl sulfate. The reaction vessel was heated to 70° C. while being purged with nitrogen with stirring. With the temperature in the vessel kept at 70° C., 4 g of potassium persulfate was added as a polymerization initiator and dissolved. Then an emulsion prepared by adding 20 g of acrylamide, 550 g of styrene, 200 g of butyl acrylate, 30 g of methacrylic acid, and 1 g of triethylene glycol diacrylate to 450 g of ion exchanged water and 2 g of sodium lauryl sulfate with stirring was continuously dropped into the reaction solution over a period of 4 hours. After dropping the emulsion, the reaction liquid was aged for 3 hours.

The resulting resin emulsion was cooled to room temperature, and ion exchanged water and ammonia water were added to the resin emulsion to adjust the solid content to 15% by weight and the pH to 8.

The resulting resin emulsion was confirmed that it does not form a film at 40° C. The weight average molecular weight was 500,000, and the volume average particle size was 40 nm.

### Resin Emulsion 3

A reaction vessel equipped with a stirrer, a reflux condenser, a dropping funnel, and a thermometer was charged with 900 g of ion exchanged water and 3 g of sodium lauryl sulfate. The reaction vessel was heated to 70° C. while being purged with nitrogen with stirring. With the temperature in the vessel kept at 70° C., 4 g of potassium persulfate was added as a polymerization initiator and dissolved. Then an emulsion prepared by adding 20 g of acrylamide, 300 g of styrene, 640 g of butyl acrylate, 30 g of methacrylic acid, and 5 g of triethylene glycol diacrylate to 450 g of ion exchanged water and 3 g of sodium lauryl sulfate with stirring was continuously dropped into the reaction solution over a period of 4 hours. After dropping the emulsion, the reaction liquid was aged for 3 hours. The resulting resin emulsion was cooled to room temperature, and ion exchanged water and 5% aqueous solution of sodium hydroxide were added to the resin emulsion to adjust the solid content to 30% by weight and the pH to 8.

The resulting resin emulsion was confirmed that it does not form a film at 40° C. The weight average molecular weight was 450,000, and the volume average particle size was 120 nm.

### Resin Emulsion 4

A reaction vessel equipped with a stirrer, a reflux condenser, a dropping funnel, and a thermometer was charged with 900 g of ion exchanged water and 3 g of sodium lauryl sulfate. The reaction vessel was heated to 70° C. while being purged with nitrogen with stirring. With the temperature in the vessel kept at 70° C., 4 g of potassium persulfate was added as a polymerization initiator and dissolved. Then an emulsion prepared by adding 20 g of acrylamide, 130 g of styrene, 780 g of ethylhexyl acrylate, 30 g of methacrylic acid, and 2 g of ethylene glycol dimethacrylate to 450 g of ion exchanged water and 3 g of sodium lauryl sulfate with stirring was continuously dropped into the reaction solution over a period of 4 hours. After dropping the emulsion, the reaction liquid was aged for 3 hours. The resulting resin emulsion was cooled to room temperature, and ion exchanged water and ammonia water were added to the resin emulsion to adjust the solid content to 15% by weight and the pH to 8.

The resulting resin emulsion formed a film at 40° C. The weight average molecular weight was 250,000, and the volume average particle size was 40 nm.

### Resin Emulsion 5

A reaction vessel equipped with a stirrer, a reflux condenser, a dropping funnel, and a thermometer was charged with 900 g of ion exchanged water and 3 g of sodium lauryl sulfate. The reaction vessel was heated to 70° C. while being purged with nitrogen with stirring. With the temperature in the vessel kept at 70° C., 4 g of potassium persulfate was added as a polymerization initiator and dissolved. Then an emulsion prepared by adding 20 g of acrylamide, 300 g of styrene, 640 g of butyl acrylate, and 30 g of methacrylic acid to 450 g of ion exchanged water and 3 g of sodium lauryl sulfate with stirring was continuously dropped into the reaction solution over a period of 4 hours. After dropping the emulsion, the reaction liquid was aged for 3 hours. The resulting resin emulsion was cooled to room temperature, and ion exchanged water and 5% aqueous solution of sodium hydroxide were added to the resin emulsion to adjust the solid content to 30% by weight and the pH to 8.

The resulting resin emulsion formed a film at 40° C. The weight average molecular weight was 300,000, and the volume average particle size was 120 nm.

Polymers of resin emulsions 6 and 7 were prepared from monomers shown in Table 2 in the same manner as water-insoluble polymers 1 to 3 used in the pigment dispersions of the color ink compositions. Values shown in Table 2 each represent a percentage of the corresponding monomer to the total amount (100%) of the monomer mixture.

TABLE 2

| Monomer mixture | Polymer of resin | Polymer of resin |
|---|---|---|
| composition (%) | emulsion 6 | emulsion 7 |
| Methacrylic acid | 20 | 15 |
| Styrene monomer | 45 | 30 |
| Benzyl methacrylate | | 10 |
| Polyethylene glycol | 5 | 20 |
| monomethacrylate | | |
| (EO = 15) | | |
| Polypropylene glycol | | 15 |
| monomethacrylate | | |
| (PO = 9) | | |
| Polyethylene glycol- | 10 | |
| polypropylene glycol | | |
| monomethacrylate | | |
| Styrene macromonomer | 20 | 10 |

EP: ethylene oxide
PO: propylene oxide

### Resin Emulsion 6

The polymer solution of the water-insoluble polymer of Resin Emulsion 6 was dried under reduced pressure, and 5 parts of dried water-insoluble polymer was dissolved in 15 parts of methyl ethyl ketone, followed by being neutralized with an aqueous solution of sodium hydroxide. After 100 parts of ion exchanged water was added to the neutralized polymer solution and stirred, the methyl ethyl ketone was removed at 60° C. under reduced pressure, and part of the water was removed to yield resin emulsion 6 having a solid content of 20% by weight.

The resulting resin emulsion formed a film at 40° C. The weight average molecular weight was 200,000, and the volume average particle size was 120 nm.

### Resin Emulsion 7

Resin emulsion 7 having a solid content of 15% by weight was prepared from the polymer solution of the water-insoluble polymer of resin emulsion 7 in the same manner as resin emulsion 6.

The resulting resin emulsion formed a film at 40° C. The weight average molecular weight was 150,000, and the volume average particle size was 90 nm.

### Preparation of Ink Compositions

Materials were mixed according to Tables 3 and 4. After being stirred for 2 hours, the mixture was filtered through a stainless steel filter of about 5 μm in pore size to yield an ink composition. The contents of the constituents shown in Tables 3 and 4 is on a percent-by-weight basis. The values within parentheses are solid contents. The amounts of the pigment dispersions and the polymers represent solid concentrations. The “balance” in the row of ion exchanged water means that ion exchanged water was added to a total of 100% by weight.

TABLE 3

| Ink composition | Ink B1 | Ink B2 | Ink B3 | Ink B4 | Ink Y1 | Ink Y2 | Ink Y3 | Ink Y4 |
|---|---|---|---|---|---|---|---|---|
| Dispersion liquid B1 | 30(4.5) | | | | | | | |
| Dispersion liquid B2 | | 40(6) | 50(7.5) | | | | | |
| Dispersion liquid B3 | | | | 30(4.5) | | | | |
| Dispersion liquid Y1 | | | | | 30(4.6) | | | 30(4.6) |
| Dispersion liquid Y2 | | | | | | 40(5.3) | | |
| Dispersion liquid Y3 | | | | | | | 30(3.8) | |
| Resin emulsion 1 | | | 10 | | | 6 | | |
| Resin emulsion 2 | | | | | 15 | | | |
| Resin emulsion 3 | 10 | 8 | | | | | 6 | |
| Resin emulsion 4 | 30 | | | 30 | | | | |
| Resin emulsion 5 | | 5 | 5 | | | | | |
| Resin emulsion 6 | | | | | | | | 10 |
| Resin emulsion 7 | | | | | | | | |
| Glycerol | 10 | 10 | 10 | 10 | 10 | 10 | 15 | 10 |
| Triethylene glycol | 2 | 5 | 5 | 5 | 5 | 3 | | 5 |
| 1,2-hexanediol | 1 | 1 | 1 | 1 | 1 | 1 | 2 | 1 |
| Trimethylolpropane | 2 | 4 | | 2 | 2 | 4 | | 2 |
| Urea | | | 2 | | | | 3 | |
| TEGmBE | 2 | 2 | 2 | 2 | 2 | 2 | 2 | 2 |
| 2-Pyrrolidone | 1 | 1 | 1 | 1 | 1 | | 2 | 1 |
| Olfine E1010 | 1 | 1 | 1 | 1 | 1 | 0.5 | 0.7 | 1 |
| Surfinol 104 | 0.5 | 0.5 | 0.1 | 0.5 | 0.5 | 0.3 | 0.7 | 0.5 |
| Potassium hydroxide | | 0.05 | | | | | | |
| Triethanolamine | 1 | | 0.5 | 1 | 1 | 1 | 1 | 1 |
| EDTA | 0.02 | 0.02 | 0.02 | 0.02 | 0.02 | 0.02 | 0.02 | 0.02 |
| Proxel XL2 | 0.3 | 0.3 | 0.3 | 0.3 | 0.3 | 0.3 | 0.3 | 0.3 |
| Ion exchanged water | Balance | Balance | Balance | Balance | Balance | Balance | Balance | Balance |
| Average particle size (nm) | 120 | 90 | 90 | 140 | 110 | 80 | 100 | 110 |

TEGmBE: triethylene glycol monobutyl ether
EDTA: Sodium ethylenediaminetetraacetate

TABLE 4

| Ink composition | Ink M1 | Ink M2 | Ink M3 | Ink M4 | Ink C1 | Ink C2 | Ink C3 | Ink C4 | Ink C5 |
|---|---|---|---|---|---|---|---|---|---|
| Dispersion liquid M1 | 30(4.6) | | | 30(4.6) | | | | | |
| Dispersion liquid M2 | | 30(5) | | | | | | | |
| Dispersion liquid M3 | | | 25(4.3) | | | | | | |
| Dispersion liquid C1 | | | | | 25(3.8) | | | | 25(3.8) |
| Dispersion liquid C2 | | | | | | 36(4) | 36(4) | | |
| Dispersion liquid C3 | | | | | | | | 30(3) | |
| Resin emulsion 1 | | | | | | | | | |
| Resin emulsion 2 | | | | | | | 10 | | |
| Resin emulsion 3 | | | | | | | | | |
| Resin emulsion 4 | | | 3 | | | | | | |
| Resin emulsion 5 | | | | | | | | 6 | |
| Resin emulsion 6 | 5 | | | | 10 | | | | |
| Resin emulsion 7 | | 2.5 | | | | 15 | | | |
| Glycerol | 10 | 10 | 15 | 10 | 10 | 10 | 10 | 10 | 10 |
| Triethylene glycol | 4 | 2 | | 5 | 7 | 5 | 5 | 5 | 9 |
| 1,2-hexanediol | 1 | 1 | 2 | 1 | 1 | 1 | 1 | 1 | 1 |
| Trimethylolpropane | 2 | 4 | | 2 | 2 | 4 | 4 | 2 | 2 |
| Urea | | | 3 | | | | | | |
| TEGmBE | 2 | 2 | 2 | 2 | 2 | 2 | 2 | 2 | 2 |
| 2-Pyrrolidone | 1 | | 2 | 1 | 1 | | | 1 | 1 |
| Olfine E1010 | 1 | 0.5 | 0.7 | 1 | 1 | 0.5 | 0.5 | 1 | 1 |
| Surfinol 104 | 0.5 | 0.3 | 0.7 | 0.5 | 0.5 | 0.3 | 0.3 | 0.5 | 0.5 |
| Triethanolamine | 1 | 1 | 1 | 1 | 1 | 1 | 1 | 1 | 1 |
| EDTA | 0.02 | 0.02 | 0.02 | 0.02 | 0.02 | 0.02 | 0.02 | 0.02 | 0.02 |
| Proxel XL2 | 0.3 | 0.3 | 0.3 | 0.3 | 0.3 | 0.3 | 0.3 | 0.3 | 0.3 |
| Ion exchanged water | Balance | Balance | Balance | Balance | Balance | Balance | Balance | Balance | Balance |
| Average particle size (nm) | 100 | 90 | 120 | 100 | 80 | 85 | 85 | 100 | 80 |

TEGmBE: Triethylene glycol monobutyl ether
EDTA: Sodium ethylenediaminetetraacetate

### Test 1

Test samples of the printing plate were made by recording a test pattern with the ink compositions shown in Tables 3 and 4 using an ink jet printer PX-1001 (manufactured by Seiko Epson). The test patterns were printed on printing paper sheets using the test samples by offset printing (lithography). The printed test patterns were visually observed to evaluate the image quality.

### Evaluation Results 1

According to the results of Test 1, while the printed materials prepared by offset printing using the printing plates made with inks Y1 to Y3, M1 to M4, and C1 to C5 had satisfactory images, the printed materials formed using the printing plate made with inks B1 to B3 had inferior images (inks B1 to B3 can be used for offset printing.)

This is probably because the pigments of inks Y1 to Y3, M1 to M4 and C1 to C5 were coated with a water-insoluble polymer, whereas the pigments of inks B1 to B3 were not coated with a water-insoluble polymer. Since the water-insoluble polymer is highly compatible (lipophilic) with offset printing inks, the image area can be made lipophilic by using inks Y1 to Y3, M1 to M4 and C1 to C5 containing pigments coated with the water-insoluble polymer.

### Test 2

Test samples of the printing plate were made by recording a test pattern with ink compositions shown in Tables 3 and 4 using an ink jet printer PX-1001 (manufactured by Seiko Epson) in the same manner as in Test 1, except that the pigment in each ink composition had a different particle size from the pigments used in Test 1. The test patterns were printed on printing paper sheets with the test samples of the printing plate by offset printing. The printed test patterns were visually observed to evaluate the image quality.

The volume average particle size of the pigments of the inks can be measured with Microtrac UPA 150 (manufactured by Microtrac) or a particle size distribution analyzer LPA 3100 (manufactured by Otsuka electronics).

### Evaluation Results 2

The evaluation results of Test 2 are shown in Table 5, including the results of Test 1.

TABLE 5
Whether
water-insoluble

| polymer was | Average particle size d | | |
|---|---|---|---|
| contained | d < 30 nm | 30 ≦ d ≦ 300 (nm) | 300 nm < d |
| Did not contain | Bad | Fair | Bad |
| as dispersant | | | |
| resin | | | |
| Contained as | Good | Excellent | Bad |
| dispersant | | | |
| resin | | | |

According to the evaluation results of Test 2, the printed materials produced by offset printing using the printing plates made with inks containing pigments having volume average particle sizes in the range of 30 to 300 nm exhibited high image quality. On the other hand, the printed materials produced by offset printing using the printing plates made with inks containing pigments having volume average particle sizes of less than 30 nm or more than 300 nm exhibited inferior image quality.

If the volume average particle size of the pigment is less than 30 nm, the particles of the pigment can penetrate the medium and cannot be sufficiently deposited on the medium. Such an ink cannot form a lipophilic image area. If the volume average particle size of the pigment is more than 300 nm, the adhesion of the pigment can be degraded and the image area may peel off during offset printing. The rub fastness of the plate can thus be inferior.

### Test 3

Test samples of the printing plate were made by recording a test pattern on plate materials at different droplet sizes using the C, M and Y color (chromatic) pigment inks shown in Tables 3 and 4 or an additionally prepared dye ink. The test patterns were printed on printing paper sheets with the test samples of the printing plate by offset printing (lithography). The printed test patterns were visually observed to evaluate the image quality.

### Evaluation Results 3

The results of Test 3 are shown in Table 6.

TABLE 6

| | Weight Im/droplet (ng) | | | |
|---|---|---|---|---|
| | | 1 ng ≦ Im ≦ | 40 ng < Im ≦ | |
| | Im < 1 ng | 40 ng | 60 ng | 60 ng < Im |
| Dye | Bad | Fair | Bad | Bad |
| Pigment | Bad | Excellent | Good | Bad |

According to the evaluation results of Test 3, the printed materials produced by offset printing using the printing plates made with pigment inks ejected at a droplet size of 1 to 60 ng exhibited high image quality. The printed materials produced by offset printing using the printing plates made with pigment inks ejected at a droplet size of 1 to 40 ng exhibited particularly high image quality. On the other hand, the printed materials produced by offset printing using printing plates made with a dye ink exhibited inferior image quality. In addition, when the printing plate was made at a droplet size of less than 1 ng or more than 60 ng, the image formed using such a printing plate was inferior in image quality even though a pigment ink was used.

This is probably because the pigments in pigment inks can remain on the printing plate and accordingly keep the image area lipophilic, whereas the ink components of dye inks are absorbed into the ink receiving layer and thus cannot keep the image area lipophilic. Also, if the droplet size (weight) is less than 1 ng, the dots formed on the printing plate can be too small, or the ink having landed can penetrate the medium, so that a sufficiently lipophilic image area cannot be formed, and thus probably gradation in pale regions cannot be expressed in the printed material. In contrast, if the droplet size is more than 60 ng, the dots formed on the printing plate are so large as to reduce the resolution of the image area, and accordingly, the image quality of the dense regions probably becomes coarse in the printed material.

In consideration of the above evaluation results, the recording method for making a printing plate described below uses color (chromatic) inks containing pigments coated with a water-insoluble polymer, and the color inks are ejected at a droplet size (weight) of 1 to 40 ng (more specifically, a small dot of 3.8 ng, a middle dot of 7.2 ng, and large dot of 14 ng).

### Structure of CTP System

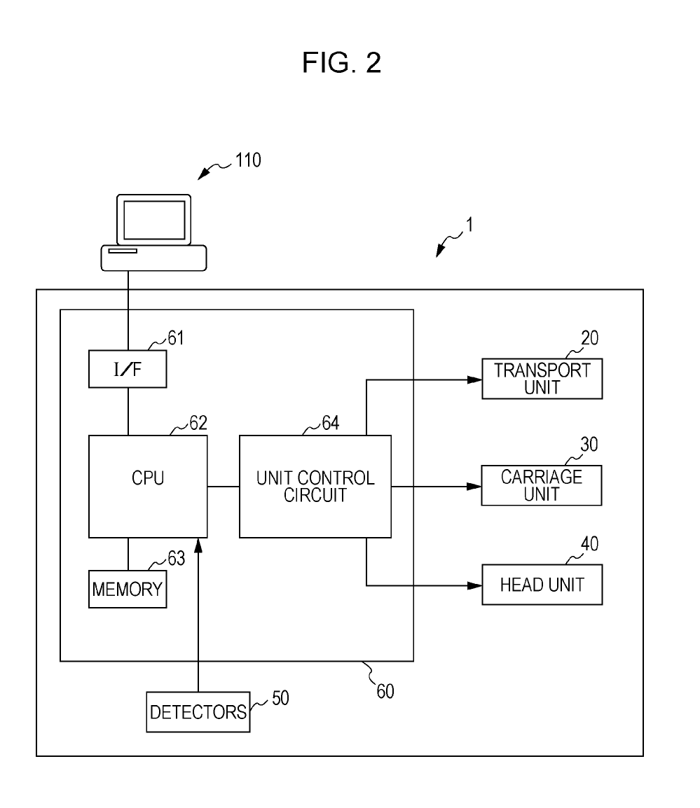

FIG. 2 is a block diagram of a CTP system. The CTP system includes an ink jet recording apparatus 1 and a computer 110.

The recording apparatus 1 is an ink jet printer. For the sake of preventing confusion with the printer used for printing using a printing plate, this apparatus is referred to as the recording apparatus. The recording apparatus 1 can not only print an image on a printing paper, but also eject an ink onto a plate material to make directly a lithographic printing plate.

The computer 110 contains an application program for preparing originals and a control program (ink jet printer driver) for controlling the ink jet recording apparatus 1.

### Recording Apparatus 1

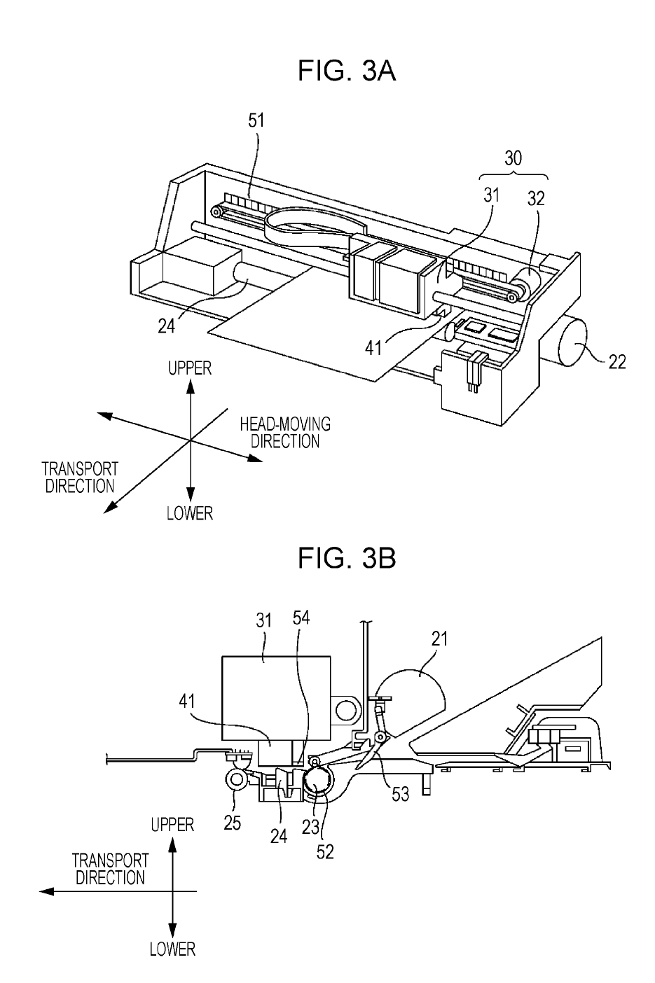

FIG. 3A is a schematic perspective view of the recording apparatus 1. FIG. 3B is a cross-sectional view of the recording apparatus 1. The fundamental structure of the recording apparatus 1 will now be described.

The recording apparatus 1 includes a transport unit 20, a carriage unit 30, a head unit 40, detectors 50, and a controller 60. The recording apparatus 1 receives imaging date from the external apparatus or computer 110 and controls each unit (transport unit 20, carriage unit 30, and head unit 40) using the controller 60. The controller 60 controls the units so as to record an image on a medium (printing paper, plate material, etc.) according to the imaging data received from the computer 110. The internal conditions of the recording apparatus 1 are monitored by the detectors 50. The detectors 50 output detection results to the controller 60. The controller 60 controls each unit according to the detection results transmitted from the detectors 50.

The transport unit 20 transports the medium in a predetermined direction (hereinafter referred to as transport direction). The transport unit 20 includes a feed roller 21, a transport motor 22, a transport roller 23, a platen 24, and an ejection roller 25. The feed roller 21 is intended to feed the medium to the interior of the recording apparatus 1. The transport roller 23 is intended to transport the medium fed by the feed roller 21 to a region where recording can be performed on the medium, and is driven by the transport motor 22. The platen 24 supports the medium during recording. The ejection roller 25 is intended to eject the medium to the outside of the recording apparatus 1, and is disposed downstream in the transport direction from the region where recording can be performed.

The carriage unit 30 moves (scans) the head in a predetermined direction (hereinafter referred to as head-moving direction). The carriage unit 30 includes a carriage 31 and a carriage motor 32. The carriage 31 is driven by the carriage motor 32 for reciprocal movement. Also, the carriage 31 removably holds a cartridge containing a plate-making ink.

The head unit 40 ejects the plate-making ink. The head unit 40 includes a head 41 having a plurality of nozzles. The head 41 is mounted on the carriage 31, and is moved together when the carriage 31 moves in the transport direction.

The detectors 50 include a linear encoder 51, a rotary encoder 52, a medium detection sensor 53, and an optical sensor 54. The linear encoder 51 detects the position of the carriage 31 in the transport direction. The rotary encoder 52 detects the amount of rotation of the transport roller 23. The medium detection sensor 53 detects the position of the front end of the medium that is being fed. The optical sensor 54 detects whether the medium is present or not, using a light emitter and a light receiver that are attached to the carriage 31. The optical sensor 54 thus detects the position of the ends of the medium to determine the width of the medium while being moved by the carriage 31. Also, the optical sensor 54 can detect the front end (one end on the downstream side in the transport direction, or upper end) and the rear end (the other end in the transport direction, or lower end) of the medium, depending on the desired configuration.

The controller 60, or control unit (control section), controls the recording apparatus 1. The controller 60 includes an interface portion 61, a CPU 62, a memory device 63, and a unit control circuit 64. The interface portion 61 provides data communication between the computer 110, or an external apparatus, and the recording apparatus 1. The CPU 62 is an arithmetic processing unit that controls the entire recording apparatus 1. The memory device 63 is intended to secure a region in which the program of the CPU 62 is stored and a working region, and includes memory elements, such as a RAM and an EEPROM. The CPU 62 controls each unit with the unit control circuit 64, according to the program stored in the memory device 63.

When recording is performed on a medium, the controller 60 allows the recording apparatus 1 to alternately perform dot-forming operation and transport operation. In the dot-forming operation, an ink is ejected from the moving nozzles onto the medium to form dots. In the transport operation, the medium is transported in the transport direction. In the description below, the dot-forming operation may be referred to as “pass”, and the n-th dot-forming operation may be referred to as “pass n”.

Computer 110

As described above, the computer 110 contains an application program for preparing originals and a control program (ink jet printer driver) for controlling the recording apparatus 1. The manner in which the computer 110 processes the plate-making operation of the recording apparatus 1 will be described more fully below, and the description of the processing for printing (the processing for using the recording apparatus 1 as a normal ink jet printer) will be omitted.

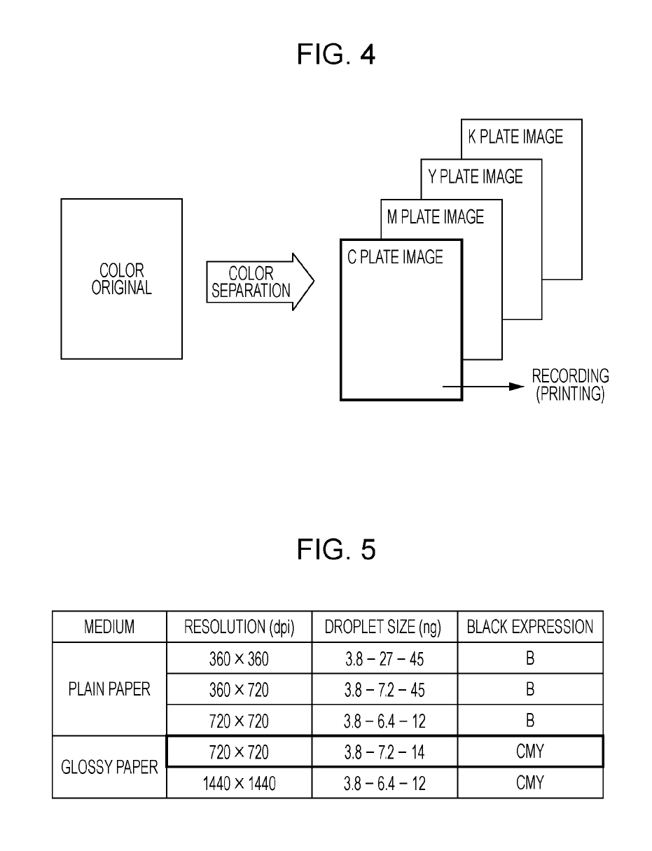

FIG. 4 is a representation of the processing of the application program performed by the computer 110. The operator prepares a color original and separates the colors of the color original, using the application program. In the present embodiment, the computer 110 separates the color original into four colors C, M, Y and K. If two-color offset printing is performed, the color original is separated into two colors. The images after color separation will be used as plate images of the respective colors for offset printing. For example, when a cyan printing plate is made, the recording apparatus 1 records the C plate image on a plate material. When the operator has directed the recording apparatus 1 to record the C plate image, using the application program, the control program starts to control the recording apparatus 1.

The processing of the application program for directing the recording apparatus 1 to record the C plate image on a plate material is the same as the processing of the application program for directing an ink jet printer to print an image on a printing paper. For recording the C plate image on a plate material, however, the control program processes the C plate image as a monochromatic image (achromatic image), but not as a cyan image.

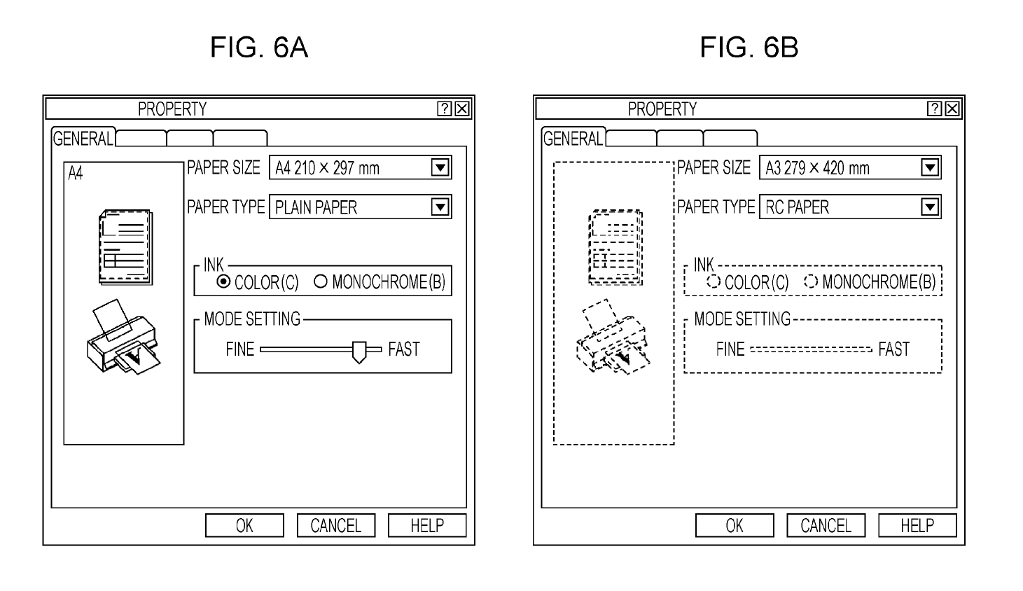

FIG. 5 is a representation of recording modes of the control program. FIGS. 6A and 6B show a setting screen on the display of the computer 110. When the paper type and recording properties have been set on the setting screen, an appropriate recording mode is selected from the recording modes shown in FIG. 5. For example, if “plain paper” and a “fast” mode are set on the setting screen, a recording mode performed at a resolution of 360×360 dpi and at ink droplet sizes of 3.8 ng in small dot, 27 ng in middle dot and 45 ng in large dot is selected, and an black images are formed with only a black ink.

The default setting of the paper type is plain paper, as shown in FIG. 6A. For cyan plate making, the operator changes the paper type setting to “plate-making RC paper” (or sets a plate-making RC paper to be used as a plate material on the recording apparatus 1). Since the recording mode for plate making has been set in advance, settings that can be changed are limited so that other settings cannot be changed on the setting screen after the paper type has been set to “plate-making RC paper”, as shown in FIG. 6B. If the paper type is set to “plate-making RC paper” on the setting screen, the recording mode is selected so that the recording will be performed at a resolution of “720×720 dpi” and at ink droplet sizes of 3.8 ng in small dot, 7.2 ng in middle dot and 14 ng in large dot, and so that a black image is formed with a composite black using the cyan, magenta and yellow inks, as in the glossy paper-fast mode.

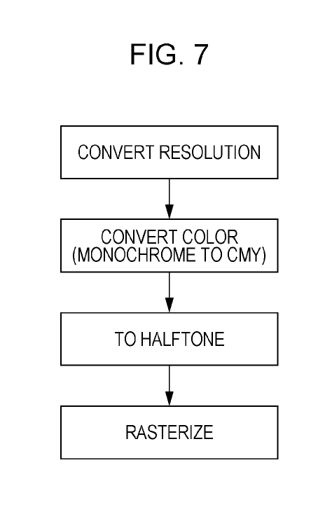

Then, the control program processes the C plate image data for converting the resolution and colors, halftone processing, and rasterizing. FIG. 7 is a flow chart showing processing operations of the control program. The processing operations of the control program will now be described.

In the resolution conversion processing, image data (including text data and graphic data) are converted into image data having a resolution (recording resolution) for recording on a medium. The C plate image data are converted into bit map image data having a resolution of 720×720 dpi by the resolution conversion processing. Each pixel data of the C plate image data after the resolution conversion processing is 256 monochromatic gray-scale data.

The color conversion converts the image data into image data of a color space that can be recorded by the recording apparatus 1. In this color conversion processing, a C plate-making monochromatic imaging data is converted into an image date of a CMY color space. The reason why the C plate-making monochromatic image is converted into an image of a CMY color space is that the present embodiment intends to record the C plate image as a monochromatic image on a plate material with a composite black using the three colors, cyan, magenta and yellow inks.

Preferably, the monochromatic C plate image is color-converted into an image of a CMY color space so that the color difference ΔE (ΔE*ab in the Lab color space) from the achromatic color (white, gray or black) of the C plate image recorded with a composite black is 10 or less, more preferably 2 or less. Consequently, the color of the C plate image recorded on the plate material does not deviate, and the visibility is good when the plate surface is visually observed immediately after the completion of plate making. If an image is recorded on the plate surface without color deviation, the density of the plate surface and the density of the printed material have a correlation. Consequently, the operator can easily estimate the density of the printed material from the density of the plate surface.

In the halftone processing, the 256 gray-scale data is converted into 4 gray-scale data (large dot, medium dot, small dot, and no dot) that can be expressed by the recording apparatus 1. The halftone processing uses, for example, a dither method, y correction, or an error diffusion method. In the imaging data after the halftone processing, two-bit pixel data corresponds to a pixel, and each pixel data represents the state of the dot in the corresponding pixel.

In the rasterizing, the pixel date arranged in a matrix manner is rearranged in dot forming order for recording. For example, if dots are formed in several steps in recording operation, imaging data is extracted corresponding to the dot forming steps and arranged in order of dot forming steps.

The processing up to the rasterizing from the resolution conversion of the C plate image data is the same as the processing up to the rasterizing from the resolution conversion of a monochromatic image that is to be printed on a glossy paper.

The control program of the computer 110 processes the C plate image data as above to prepare imaging data, and transmits the imaging data to the recording apparatus 1. The controller 60 of the recording apparatus 1 controls the units so as to record the C plate image on a medium, according to the imaging data received from the computer 110.

### Recording Method

### Nozzle Arrangement

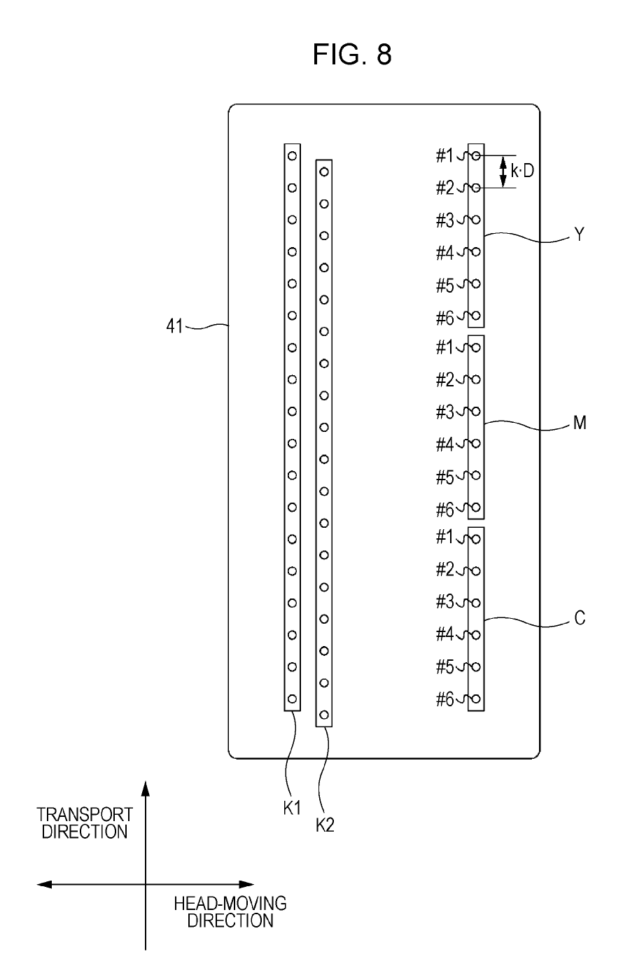

FIG. 8 is an arrangement of nozzles of the head 41 of the recording apparatus 1. A first black nozzle line K1, a second black nozzle line K2, a cyan nozzle line C, a magenta nozzle line M, and a yellow nozzle line Y are formed on the bottom surface of the head 41. The two black nozzle lines K1 and K2 are arranged in parallel in the head moving direction. The three color nozzle lines C, M and Y are aligned in a line in the transport direction.

The first black nozzle line K1 has 180 nozzles aligned at regular intervals of 1/180 inches in the transport direction (for the sake of simplicity, FIG. 8 shows fewer nozzles than may actually be used in practice). The second black nozzle line K2 also has 180 nozzles aligned at regular intervals of 1/180 inches in the transport direction in the same manner as the first black nozzle line K1. However, the first black nozzle line K1 and the second black nozzle line K2 are displaced in the transport direction by half the pitch of the nozzles, that is, by 1/360 inches. For monochromatic printing with only a black ink, dots are formed in the transport direction at a resolution of 360 dpi by one operation of moving the head.

The cyan nozzle line C, the magenta nozzle line M and the yellow nozzle line Y each have 60 nozzles aligned at regular intervals of 1/180 inches in the transport direction. For the sake of simplicity, the figure simply shows 6 nozzles in each color nozzle line. The nozzles of each nozzle line are numbered from the downstream side of the transport direction in increasing order (#1 to #6 in FIG. 8).

The black ink ejected from the first and second black nozzle lines K1 and K2 is any one of the above-described inks B1 to B3 whose pigments are not coated with a water-insoluble polymer. The cyan ink ejected from the cyan nozzle line C is any one of the above-described inks C1 to C5 whose pigments are coated with a water-insoluble polymer. The magenta ink ejected from the magenta nozzle line M is any one of the above-described inks M1 to M4 whose pigments are coated with a water-insoluble polymer. The yellow ink ejected from the yellow nozzle line Y is any one of the above-described inks Y1 to Y3 whose pigments are coated with a water-insoluble polymer.

Preferably, the resin emulsions in the cyan, magenta and yellow inks have different properties. In this instance, the composite black of the three color inks can exhibit a higher fixability and rub fastness than the case where the resin emulsions in the three color inks have the same properties.

### Overlap Recording

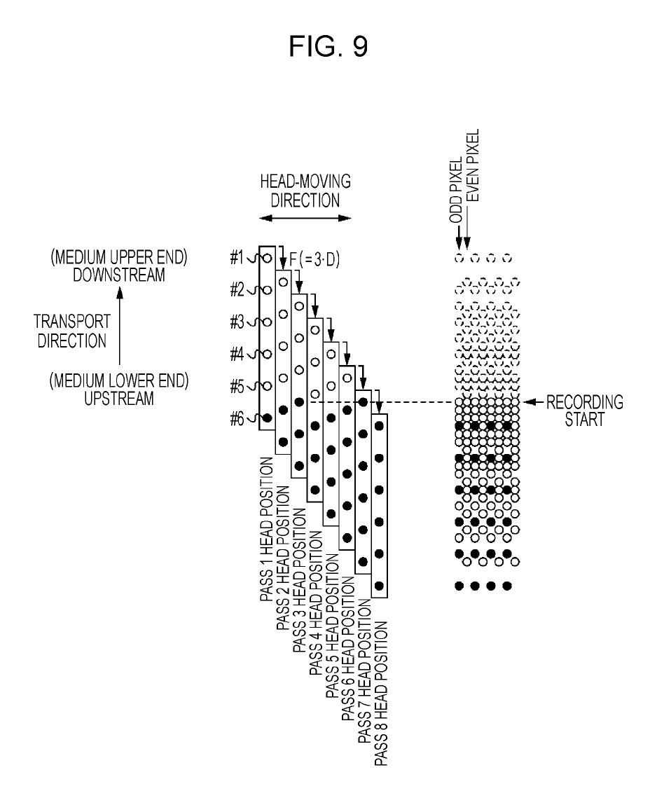

FIG. 9 is a representation of the position of color nozzle lines and the formation of corresponding dots. FIG. 9 shows only one of the three color nozzle lines. Nozzles represented by filled circles can eject ink. Nozzles represented by open circles cannot eject ink. Although the nozzle line seems to move with respect to the medium, FIG. 9 shows a relative position of the nozzle line to the position of the medium, for the sake of convenience, and the medium also moves in the transport direction in practice. Also, in the figure, it seems that the nozzles form only several dots (circles in the figure) in the head-moving direction. However, in practice, the nozzles moving in the head-moving direction eject ink droplets to form a large number of dots in the head-moving direction. The lines defined by dots are referred to as raster lines. The dots represented by filled circles are formed by the last pass, and the dots represented by open circles are formed by passes prior to the last pass. The passes are performed alternately with the operations of transporting the medium in the transport direction.

The controller 60 of the recording apparatus 1 allows the nozzles to eject an ink to form a dot in each pixel on the medium according to the imaging data received from the computer 110. Dots may not be formed in some pixels depending on the imaging data. The dots shown in FIG. 9 are formed in all the pixels, for the sake of easier representation.

As shown in FIG. 9, each raster line is recorded by two nozzles. This recording manner, in which each raster line is recorded by a plurality of nozzles, is referred to as overlap recording.

In the overlap recording method, each nozzle intermittently forms a dot every time the medium is transported at a certain transport quantity F in the transport direction. Then, the line of intermittent dots that have been formed by other nozzles is complemented so as to fill the spaces between the dots in other passes. Thus a raster line is formed by a plurality of nozzles. When a raster line is formed by M times of passes, the overlap number is defined as M.

In FIG. 9, each nozzle intermittently forms a dot every two dots. Thus, dots are formed in either odd pixels or even pixels in each pass. Each raster line is formed by two nozzles, and hence, the overlap number M is 2.

In order to keep the transport quantity F constant in the overlap recording method, the following requirements must be satisfied: (1) N/M is integer; (2) N/M and k are both prime numbers; and (3) the transport quantity F is set to (N/M)·D. N represents the number of nozzles that eject ink (N=6 in the example shown in FIG. 9). D represents the dot pitch ( 1/720 inches in this example). The variable k represents a multiple number (integer) of the nozzle pitch (k·D) to the dot pitch D. Since the nozzle pitch is 1/180 inches, k is 4 in the example shown in FIG. 9. In this case, since M is 2, the transport quantity F is 3·D (=(6/2)·D).

When a raster line is formed by M nozzles, k×M times of passes are performed to complete raster lines corresponding to the nozzle pitch. In FIG. 9, for example, since each raster line is formed by two nozzles, 8 times of passes are performed to complete 4 raster lines. In the overlap recording method using a plurality of nozzles, therefore, the number of times of passes performed to complete raster lines corresponding to the nozzle pitch is increased in comparison with a recording method that forms a raster line by a single nozzle.

FIG. 10 is a representation of an overlap recording method performed by two nozzle lines aligned in the transport direction. FIG. 10 simply shows the cyan nozzle line C and the magenta nozzle line M of the three color nozzle lines. The nozzles on the left represented by circles are in the cyan nozzle line C disposed at the upstream side of the transport direction. The nozzles represented by triangles are in the magenta nozzle line M disposed at the downstream side of the transport direction. Nozzles represented by filled circles or triangles can eject ink. Nozzles represented by open circles or triangles cannot eject ink. The dots represented by circles at the right in the figure are those formed by the nozzles of the cyan nozzle line. The dots represented by triangles are those formed by the nozzles of the magenta nozzle line. The magenta dots represented by triangles are formed on the cyan dots.

Even when a plurality of nozzle lines are aligned in the transport direction, as shown in FIG. 10, each nozzle line performs recording by the overlap recording method as shown in FIG. 9. Although FIG. 10 does not show the yellow nozzle line Y (see FIG. 8), it is disposed to the downstream side of the magenta nozzle line M in the transport direction, and performs recording by the overlap recording method as shown in FIG. 9.

The magenta nozzle line M at the downstream side of the transport direction forms magenta dots over the region where cyan dots have been formed. For example, in several raster lines around the recording start point, cyan dots are formed by passes 1 to 8 (see FIG. 9), and then magenta dots are formed over the cyan dots by passes 9 to 16 (see FIG. 10). Also, the yellow nozzle line Y, not shown in FIG. 10, disposed to the downstream side of the magenta nozzle line M in the transport direction forms yellow dots over the cyan dots and magenta dots.

If the plurality of nozzle lines are arranged in the head-moving direction, but not in the transport direction, these nozzle lines form dots in the same region at substantially the same time. On the other hand, if the nozzle lines are aligned in the transport direction, as in the present embodiment, one nozzle line disposed to the downstream side of another nozzle line in the transport direction forms dots by different pass over the dots formed by the upstream nozzle line. More specifically, if the nozzle lines are aligned in the transport direction, as in the present embodiment, one nozzle line disposed at the upstream side of the transport direction forms dots, subsequently the medium is transported, and then another nozzle line disposed at the downstream side forms dots by different pass over the dots previously formed by the upstream nozzle line. In other words, in an arrangement in which a plurality of nozzle lines are aligned in the transport direction, as in the present embodiment, the timing of dot forming can differ between the nozzle lines.

As described above, in the overlap recording method that forms a raster line using a plurality of nozzles, the number of times of passes to complete raster lines corresponding to the nozzle pitch is increased. If the nozzle lines are aligned in the transport direction, as shown in FIG. 10, one nozzle line disposed at the upstream side of the transport direction forms dots in a region by k×M times of passes, and then another nozzle line disposed at the downstream side of the transport direction forms dots in the same region by k×M times of passes. Accordingly, if each of the nozzle lines aligned in the transport direction performs the overlap recording method, the time that elapses before dots are overlaid can be increased. In other words, in an arrangement in which a plurality of nozzle lines are aligned in the transport direction, as in the present embodiment, the interval between the timings at which the nozzle lines form dots can be increased by using the overlap recording method.

For plate making in the present embodiment, the recording mode is selected so that black images can be expressed by a composite black using cyan, magenta and yellow inks (see the row surrounded by the bold line in FIG. 5). Therefore, the recording apparatus 1 records the monochromatic C plate image on a plate material (plate-making RC paper) using a cyan ink, a magenta ink, and a yellow ink. In a dense region of the C plate image, consequently, the cyan ink, the magenta ink and the yellow ink are applied so as to overlay each other in the same pixel. By applying the plate-making cyan ink, magenta ink and yellow ink so as to overlay each other in the same region on a plate material, the image area expressed by the composite black can exhibit an enhanced fixability and rub fastness, and lipophilicity sufficient for offset printing.

In the present embodiment, for example, the recording apparatus 1 forms cyan dots by the cyan nozzle line C, subsequently transport the medium, and then forms magenta dots on the cyan dots by the magenta nozzle line M. Consequently, the timing of dot forming can differ by the time to transport the medium between the nozzle lines. More specifically, after a previously applied plate-making ink has been absorbed into the ink-receiving layer of the plate material, a subsequent plate-making ink can be applied to the same region. Consequently, the image area expressed by the composite black can exhibit enhanced fixability and rub fastness, and lipophilicity sufficient for offset printing.

In the recording apparatus 1 of the present embodiment, the color nozzle lines are aligned in the transport direction. In this arrangement of the nozzle lines, for example, the recording apparatus 1 can form cyan dots by the cyan nozzle line C, and then form magenta dots in the same region by the magenta nozzle line M.

In the present embodiment, also, printing plates are made by the overlap recording method. Since the overlap recording method records each raster line (dot line) with a plurality of nozzles, the interval between the timings at which the nozzle lines form dots can be increased. More specifically, after a previously applied plate-making ink has been sufficiently absorbed into the ink-receiving layer of the plate material, a subsequent plate-making ink can be applied to the same region. Consequently, the image area expressed by the composite black can exhibit enhanced fixability and rub fastness, and lipophilicity sufficient for offset printing.

In the present embodiment, the C plate image is recorded on a plate material as a monochromatic (achromatic) image with a composite black using three color chromatic plate-making inks of cyan, magenta and yellow. Thus, the visibility is high in visually checking the plate surface immediately after the completion of plate making. If a printing plate is made with only a yellow ink, the visibility in visually checking the plate surface is degraded due to the pale color of the yellow ink.

The achromatic C plate image is formed with three color chromatic plate-making inks of cyan, magenta and yellow, and the image area, at least in the dense region, is formed by overlaying different color dots one after another. Consequently, the image area can exhibit enhanced fixability and rub fastness, and lipophilicity sufficient to offset printing.

In the present embodiment, the color difference ΔE (ΔE*ab in the Lab color space) from the achromatic color (white, gray or black) of the C plate image recorded with a composite black is 10 or less, preferably 2 or less (the above-described color conversion is performed so that the color difference ΔE can be in this range.) Consequently, the color of the C plate image recorded on the plate material does not deviate, and the visibility can be high in visually checking the plate surface immediately after the completion of plate making. In addition, by recording the image on the plate surface without color deviation, the operator can easily estimate the density of the printed material from the density of the plate surface.

The above-described embodiments are described for the sake of easy understanding, but are not intended to limit the invention. It is to be understood that various modifications may be made without departing from the scope and spirit of the invention, and that the invention includes equivalents thereof.

For example, the recording apparatus may be of line type in which a plurality of stationary heads are arranged in a line, but not of serial type that performs recording while the head are moving in the head-moving direction.

What is claimed is:

1. A method for making a lithographic printing plate comprising:
forming an image area on a medium by ejecting an ink onto the medium from a head,
wherein the ink contains a water-insoluble polymer acting as a dispersant resin, a pigment coated with the water-insoluble polymer, and a surfactant.

2. The method according to claim 1, wherein the pigment has an average particle size in the range of 30 to 300 nm.

3. The method according to claim 1, wherein the water-insoluble polymer has a solubility of less than 1 g in 100 g of water at 25° C.

4. The method according to claim 1, wherein the forming of the image area is performed by ejecting a plurality of chromatic inks onto the medium from the head to form an achromatic image on the medium.

5. A lithographic printing plate comprising:
a support;
an ink-receiving layer that receives an ink; and
an image area defined by applying an ink to the ink-receiving layer from an ink jet recording apparatus, the ink containing a water-insoluble polymer acting as a dispersant resin, a pigment coated with the water-insoluble resin, and a surfactant.

6. The lithographic printing plate according to claim 5, wherein the pigment has an average particle size in the range of 30 to 300 nm.

7. The lithographic printing plate according to claim 5, wherein the water-insoluble polymer has a solubility of less than 1 g in 100 g of water at 25° C.

8. The lithographic printing plate according to claim 5, wherein the image area is defined by ejecting a plurality of chromatic inks onto the ink-receiving layer from the ink jet recording apparatus to form an achromatic image area on the ink-receiving layer.

9. A lithographic printing plate making apparatus comprising:
a head that ejects an ink containing a water-insoluble resin acting as a dispersant resin, a pigment coated with the water-insoluble polymer, and a surfactant; and
a control section that controls the head so as to eject the ink onto a medium to form an image area on the medium.

10. The lithographic printing plate making apparatus according to claim 9, wherein the pigment has an average particle size in the range of 30 to 300 nm.

11. The lithographic printing plate making apparatus according to claim 9, wherein the water-insoluble polymer has a solubility of less than 1 g in 100 g of water at 25° C.

12. The lithographic printing plate making apparatus according to claim 9, wherein the image area is formed by ejecting a plurality of chromatic inks onto the medium from the head to form an achromatic image area on the medium.
